(19) United States
(12) Patent Application Publication
(10) Pub. No.: US 2026/0132022 A1
(43) Pub. Date: May 14, 2026

(54) THREE-DIMENSION STACKED PHOTOCATALYTIC DEVICE

(71) Applicant: National Tsing Hua University, Hsinchu (TW)

(72) Inventors: Ho-Hsiu Chou, Hsinchu (TW); Yu-En Sun, Hsinchu (TW)

(21) Appl. No.: 19/007,607

(22) Filed: Jan. 2, 2025

(30) Foreign Application Priority Data
Nov. 14, 2024 (TW) 113143881

(51) Int. Cl. C01B 3/04

(52) U.S. Cl. CPC C01B 3/042; C01B 2203/0277

(57) ABSTRACT

The present application provides a three-dimensional stacked photocatalytic device, which comprises a support frame and a first integrated component. The first integrated component includes a first bottom plate, a first receiving tank and a first top plate. The first bottom plate is pivoted on a first pivot hole of the support frame, the first accommodation slot is disposed on the first bottom plates, and a first photocatalytic component is disposed in the first accommodation slot, and the first top plate is disposed on the first accommodating grooves, wherein a light passes through the first top plate and the first photocatalytic component sequentially, causing the first photocatalytic component to generate a gas, and the first bottom plate is configured to rotate on the first pivot hole and drive the first integrated component to rotate for adjusting the irradiation angle of the first photocatalytic component.

### FIELD OF THE INVENTION

The present application relates to a three-dimension (3D) stacked photocatalytic device, particularly to a photocatalytic device capable of adjusting irradiation angles, suitable for various photocatalytic applications including water splitting for hydrogen generation and carbon dioxide photocatalytic reduction reactions. This 3D design focuses on improving the light energy utilization per unit area, improving the photocatalytic efficiency.

### BACKGROUND OF THE INVENTION

Photocatalytic technology has shown great potential in environmental and energy applications, especially in the fields of water splitting for hydrogen generation and carbon dioxide photocatalytic reduction. However, existing photocatalytic devices have lower light energy utilization per unit area, leading to catalytic efficiency failing to be optimized.

Concurrently, developing more efficient devices to enhance the light energy utilization per unit area has become an important issue. Traditional photocatalytic devices often rely on flat designs, which cannot fully utilize the limited surface area to obtain maximum photocatalytic effects. In light of the problems with the well-known photocatalytic technologies, the present application provides a 3D stacked photocatalytic device, which includes a photocatalytic component capable of adjusting irradiation angles. By the 3D stacked structural design, the utilization of light energy per unit area will effectively increase, the overall efficiency of photocatalytic reactions will be improved. The 3D stacked structural design is applicable to various photocatalytic reactions, including but not limited to water splitting for hydrogen generation and carbon dioxide photocatalytic reduction, thereby significantly improving the conversion efficiency in renewable energy applications.

### SUMMARY OF THE INVENTION

An objective of the present application is to provide a three-dimensional stacked photocatalytic device, which includes a support frame pivoted with an integrated component. The integrated component includes an accommodation slot and a photocatalytic component, utilizing the integrated component with adjustable irradiation angles to allow the photocatalytic component adjust the irradiation angles to continuously irradiate light, thereby improving the photocatalytic efficiency of the 3D stacked photocatalytic device.

To achieve the aforementioned objectives and effects, the present application provides a 3D stacked photocatalytic device that receives a liquid. This device includes a support frame and a first integrated component. The support frame has a first pivot hole on one side, and the first integrated component includes a first base plate, a first accommodation slot, and a first top plate. The first base plate is pivotally connected to the first pivot hole, and the first accommodation slot is disposed on the first base plate. A first photocatalytic component is disposed inside the first accommodation slot, and the first top plate is disposed on the first accommodation slot. A first upper through-hole is perforated at a corner of the first top plate corresponding to the first photocatalytic component, connecting to the inside of the first accommodation slot. The liquid enters the inside of the first accommodation slot through the first upper through-hole. The first base plate rotates on the first pivot hole and drives the first integrated component to rotate, directing a light onto the first top plate to pass through the first top plate and irradiate the first photocatalytic component in the first accommodation slot, causing the first photocatalytic component to decompose the liquid and generate a gas. The gas flows out from the inner side of the first accommodation slot through the first upper through-hole; this structure provides an adjustable angle to improve the photocatalytic efficiency of the device.

According to one embodiment of the present application, the first base plate including a reflective layer.

According to one embodiment of the present application, the first photocatalytic component includes a first polymer material, which is disposed on the inner side of the first accommodation slot.

According to one embodiment of the present application, the first photocatalytic component further includes a first substrate, which is disposed on the inner side of the first accommodation slot, and the first polymer material is coated on the first substrate.

According to one embodiment of the present application, a second pivot hole is disposed on the side of the support frame and corresponding to an upper side of the first pivot holes.

According to one embodiment of the present application, it further includes a second integrated component comprising: a connecting tube, which connects to the first upper through-hole at an end; a second base plate, pivotally connected to the second pivot hole at a side, and including a lower through-hole perforated the second base plate, the lower through-hole connected to the other end of the connecting tube; a second accommodation slot, disposed on the second base plate, with a second photocatalytic component disposed on an inner side of the second accommodation slot, the second accommodation slot connects to the lower through-hole; a second top plate, disposed on the second accommodation slot, with a second upper through-hole perforated the corner of second top plate corresponding to the second photocatalytic component, the second upper through-hole connects to the inner side of the second accommodation slot; wherein, the second base plate rotates on the second pivot hole and drives the second integrated component to rotate, directing the light onto the second top plate to pass through the second top plate and irradiate the second photocatalytic component in the second accommodation slot, causing the second photocatalytic component to generate the gas, the gas flows out from the inner side of the second accommodation slot through the second upper through-hole.

According to one embodiment of the present application, the second photocatalytic component includes a second polymer material, which is disposed on the inner side of the second accommodation slot.

According to one embodiment of the present application, the second photocatalytic component further includes a second substrate, which is disposed on the inner side of the second accommodation slot, and the second polymer material is coated on the second substrate.

According to one embodiment of the present application, a second auxiliary accommodation slot is disposed on the second accommodation slot, and disposed between the second accommodation slot and the second top plate, the second auxiliary accommodation slot includes a second auxiliary photocatalytic component disposed on an inner side of the second auxiliary accommodation slot.

According to one embodiment of the present application, the materials of the first photocatalytic component and the second photocatalytic component are different from each other.

According to one embodiment of the present application, the gas includes hydrogen and the liquid includes water.

### BRIEF DESCRIPTION OF DRAWINGS

FIG. 1: which is a schematic diagram according to the first embodiment of the invention;

FIG. 2: which is an exploded view diagram according to the first embodiment of the present application;

FIG. 3A to FIG. 3B: which are operational diagrams according to the first embodiment of the present application;

FIG. 4: which is a sectional view diagram according to the first embodiment of the present application;

FIG. 5A to FIG. 5C: which are structural and operational schematic diagrams according to the second embodiment of the present application;

FIG. 6: which is a sectional view diagram according to the second embodiment of the present application; and

FIG. 7A to FIG. 7B: which are schematic diagrams of the a plurality of slot structures according to one embodiment of the present application.

### DETAILED DESCRIPTION OF THE INVENTION

In light of the problems of the well-known technologies, the present application is to provide a first integrated component pivotally connected to a support frame, using the first integrated component capable of adjusting angles, during light irradiation, correspondingly adjusting the irradiation angle, allowing the light to continuously pass through the first top plate and the first photocatalytic component in sequential, causing the first photocatalytic component to generate a gas.

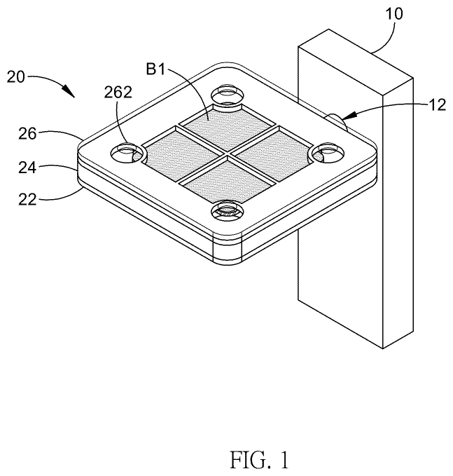

Please refer to FIG. 1, which is a schematic diagram of the structure of the first embodiment of the present application. As shown in the figure, this embodiment is the first embodiment to provide a three-dimensional stacked photocatalytic device, comprising a support frame 10 and a first integrated component 20, wherein the support frame 10 is configured to support the first integrated component 20.

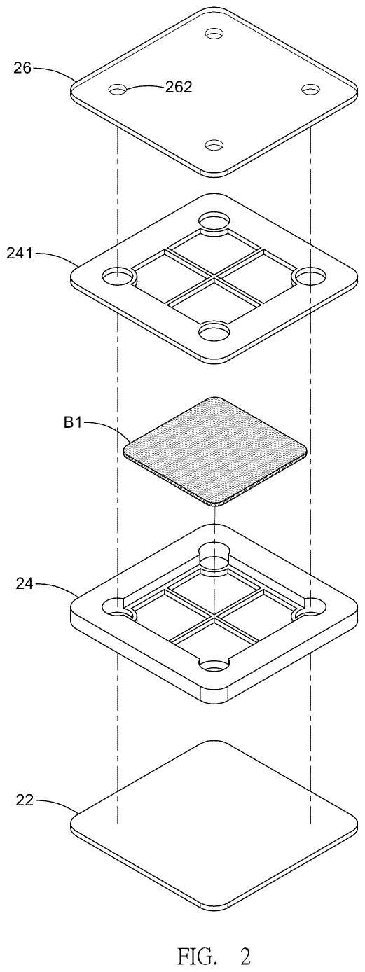

Refer to FIG. 1 and FIG. 2 again, FIG. 2 is a structural exploded view according to the first embodiment of the present application. As shown in the figure, in this embodiment, the support frame 10 includes a first pivot hole 12 at a side thereof, the first integrated component 20 includes a first base plate 22, a first accommodation slot 24 and a first top plate 26. The first base plate 22 is pivotally connected to the first pivot hole 12 at a side thereof, the first accommodation slot 24 is disposed on the first base plate 22, the first accommodation slot 24 includes a first Photocatalytic Component B1 disposed at an inner side of the first accommodation slot 24, the first top plate 26 is disposed on the first accommodation slot 24, the corner of the first top plate 26 corresponding to the first Photocatalytic Component B1 has a first upper through-hole 262, the first upper through-hole 262 connects the inner side of the first accommodation slot 24, allowing liquids and gases to flow in the inner side of the first accommodation slot 24 or flow out the first accommodation slot 24.

In one embodiment, the seam between the first base plate 22 and the first accommodation slot 24 is sealed to prevent liquids or gases from leakage.

In one embodiment, the first accommodation slot 24 includes a cover 241, the cover 241 and the first accommodation slot 24 clamp the first photocatalytic component B1, the cover 241 includes a through-hole correspond to the first upper through-hole 262 of the first top plate 26, allowing fluids or gases to pass through.

In one embodiment, the seam between the first accommodation slot 24 and the first top plate 26 is sealed to prevent liquids or gases from leakage.

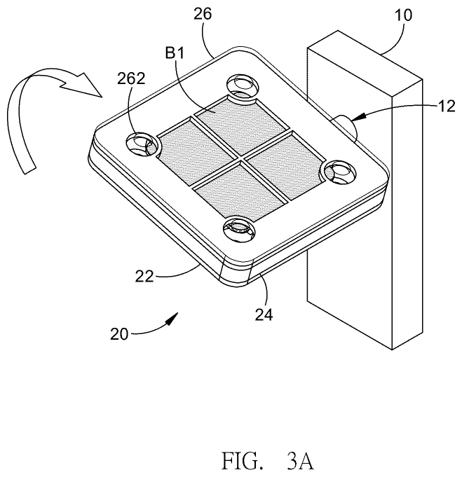

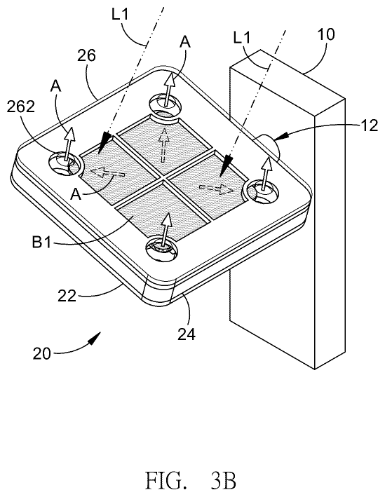

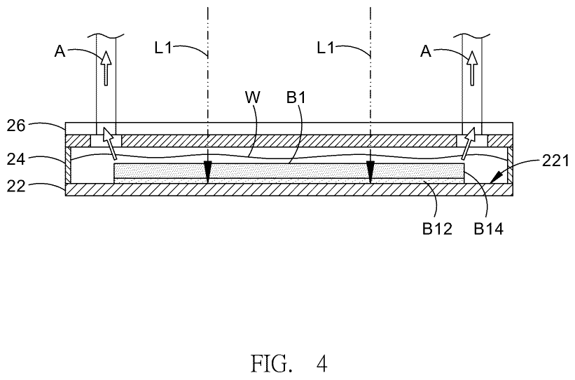

Referring again to FIG. 1, FIG. 2, and FIG. 3A to FIG. 3B as well as FIG. 4, FIG. 3A to FIG. 3B are the operational schematic diagrams of the first embodiment of the present application, and FIG. 4 is the sectional schematic diagram of the first embodiment of the present application. As shown in the figures, this embodiment is based on the aforementioned first embodiment, wherein in this embodiment, the first base plate 22 of the first integrated component 20 rotates on the first pivot hole 12, and the first base plate 22 drives the overall rotation of the first integrated component 20 to correspondingly adjust the angle of the first integrated component 20.

Continued to above, when in use, first add a liquid W to the inner side of the first accommodation slot 24, the liquid W enters the inner side of the first accommodation slot 24 through the first upper through-hole 262, so that the first photocatalytic component B1 soaks in the liquid W, then an external light ray L1 is directed to the first top plate 26, since the first top plate 26 is transparent, allowing the light ray L1 pass through the first top plate 26 and irradiate the first photocatalytic component B1 in the first accommodation slot 24, causing the first photocatalytic component B1 to decompose the liquid W and generate a gas A (only part marked in the diagram), the gas A then flows out from the inner side of the first accommodation slot 24 through the first upper through-hole 262 for collection.

Continued to above, in one embodiment, the liquid W includes water, the gas A includes hydrogen, and the first photocatalytic component B1 decomposes the liquid W to generate hydrogen ions and hydroxide ions.

Continued to above, in one embodiment, the first photocatalytic component B1 includes a first polymer material B14, which is disposed on the inner side of the first accommodation slot 24.

Continued to above, wherein the first polymer material B14 may be selected from the group consisting of polypropylene glycol, Poly(propylene glycol), tolylene 2,4-diisocyanate terminated (PTD), 3-(4,4-bis(2-ethylhexyl)-6-methyl-4H-cyclopenta[2,1-b:3,4-b′]dithiophen-2-yl)-7-methyldibenzo[b,d]thiophene 5,5-dioxide □ PCPDTDBT) and 3-methyl-7-(7-methyl-9,9-dioctyl-9H-fluoren-2-yl)-5-phenylbenzo[b]phosphindole 5-oxide (PFBPO).

Continued to above, in one embodiment, the first photocatalytic component B1 further includes a first substrate B12, which is disposed on the inner side of the first accommodation slot 24, and the first polymer material B14 is coated on the first substrate B12.

Continued to above, in one embodiment, the wavelength of the light ray L1 includes 250 nm to 650 nm, but it is not limited to this wavelength range of the light ray L1.

Continued to above, in one embodiment, the first base plate 22 includes a reflective layer 221, which reflects the light ray L1, increasing the irradiation of the first photocatalytic component B1, thereby, enhancing the photocatalytic efficiency of the first photocatalytic component B1.

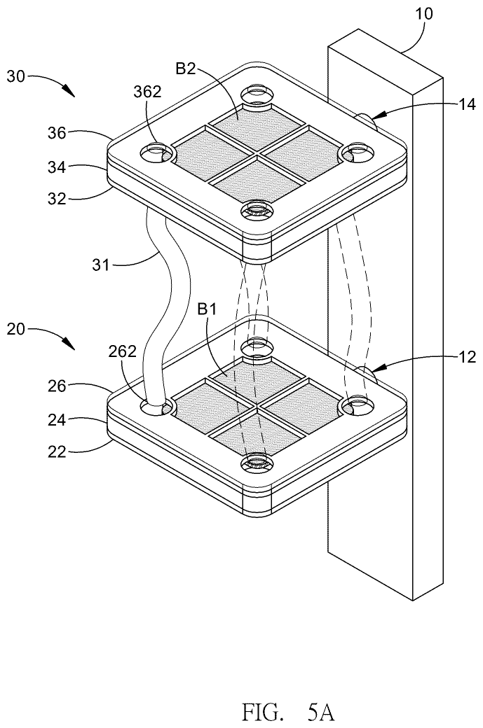

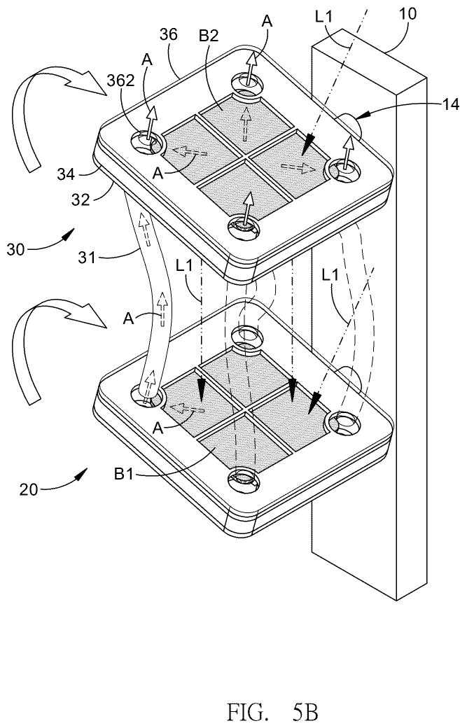

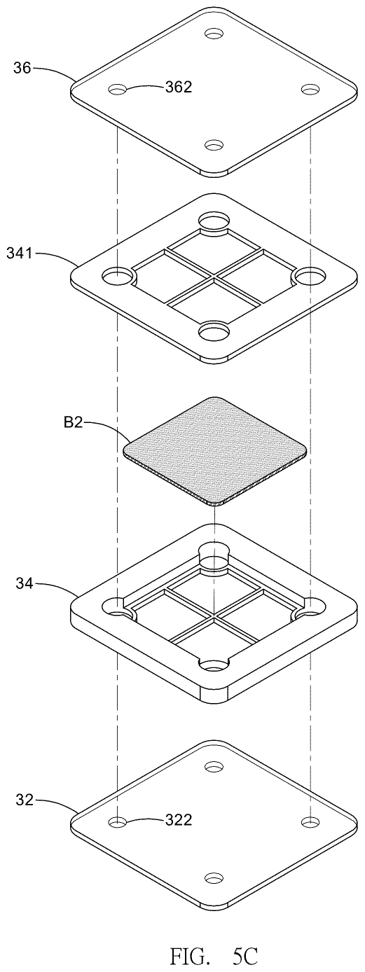

Refer to FIG. 5A to FIG. 5C, which illustrate the structure and operation schematic diagram according to the second embodiment of the present application. As shown in the figures, this embodiment, based on the first embodiment, further includes a second integrated component 30 and a second pivot hole 14 disposed on the first pivot hole 12 on the side of the support frame 10. The second integrated component 30 comprises a connecting tube 31, a second base plate 32, a second accommodation slot 34, and a second top plate 36. An end of the connecting tube 31 connects to the first upper through-hole 262 for receiving gas A and transporting liquid W. The second base plate 32 is pivotally connected to the second pivot hole 14 and has a through-hole 322, which connects to the other end of the connecting tube 31. The second accommodation slot 34 is disposed on the second base plate 32 and houses a second photocatalytic component B2 on one inner side. The second accommodation slot 34 connects to the through-hole 322. The second top plate 36 is disposed on the second accommodation slot 34 and has a second upper through-hole 362 corresponding to the corner of the second photocatalytic component B2, connecting to the inner side of the second accommodation slot 34, allowing liquids and gases to flow into or out of the inner side of the second accommodation slot 34.

In one embodiment, similarly, the seams between the second base plate 32 and the second accommodation slot 34, as well as between the second accommodation slot 34 and the second top plate 36, are sealed to prevent leakage of liquids or gases.

In one embodiment, the second accommodation slot 34 includes a cover 341, which clamps the second photocatalytic component B2 with the second accommodation slot 34. The cover 341 is perforated to align with and connect to the second upper through-hole 362 of the second top plate 36, allowing fluids or gases to pass through.

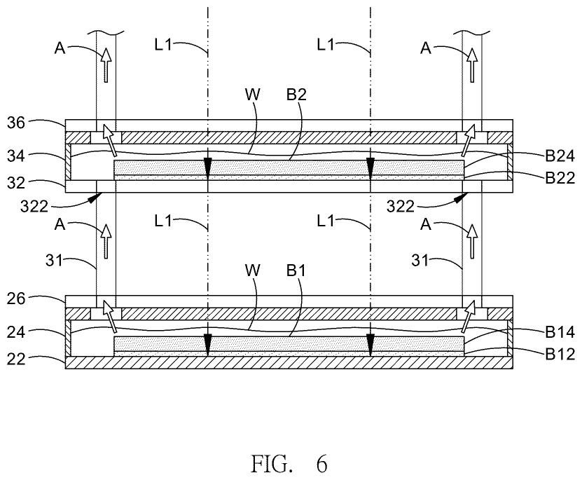

Referring to FIG. 5A to FIG. 5C and FIG. 6 again, FIG. 6 is a cross-sectional schematic diagram according to the second embodiment of the present application. As shown in the figure, this embodiment is based on the aforementioned second embodiment. In this embodiment, similar to the first integrated component 20, the second base plate 32 of the second integrated component 30 rotates at the second pivot hole 14, and the second base plate 32 drives the overall rotation of the second integrated component 30 to correspondingly adjust the angle of the second integrated component 30.

Continued to above, when in use, first add the liquid W to one inner side of the second accommodation slot 34, soaking the second photocatalytic component B2. Since the second accommodation slot 34 is connected to the first accommodation slot 24 via the connecting tube 31, part of the liquid W flows into the first accommodation slot 24 soaking the first photocatalytic component B1. Then, the external light L1 is directed to the second top plate 36. Since the second top plate 36 is transparent, the light L1 passes through the second top plate 36 and strikes the second photocatalytic component B2 in the second accommodation slot 34, causing the second photocatalytic component B2 to decompose the liquid W to generate the gas A (only part shown in the figure). The gas A then flows out from the inner side of the second accommodation slot 34 through the second upper through-hole 362 for collection.

Continued to above, since the second integrated component 30 is disposed on the first integrated component 20, and the second base plate 32 of the second integrated component 30 is transparent, the light L1 passing through the second integrated component 30 can further be directed to the first integrated component 20. The path of the light is the same as in the first embodiment, thus no further explanation is needed.

Continued to above, the gas A generated by the first integrated component 20 is transported through the connecting tube 31 to the inner side of the second accommodation slot 34, then the gas A exits through the second upper through-hole 362 for collection.

Continued to above, in one embodiment, the second photocatalytic component B2 includes a second polymer material B24, which is disposed on the inner side of the second accommodation slot 34.

Continued to above, wherein the second polymer material B24 may be selected from the group consisting of polypropylene glycol, Poly(propylene glycol), tolylene 2,4-diisocyanate terminated (PTD), 3-(4,4-bis(2-ethylhexyl)-6-methyl-4H-cyclopenta[2,1-b:3,4-b′]dithiophen-2-yl)-7-methyldibenzo[b,d]thiophene 5,5-dioxide □ PCPDTDBT) and 3-methyl-7-(7-methyl-9,9-dioctyl-9H-fluoren-2-yl)-5-phenylbenzo[b]phosphindole 5-oxide (PFBPO).

Continued to above, in one embodiment, the second photocatalytic component B2 further includes a second substrate B22, which is disposed on the inner side of the second accommodation slot 34, the second polymer material B24 is coated on the second substrate B22.

Continued to above, in one embodiment, the material of the first photocatalytic component B1 and the second photocatalytic component B2 are different, effectively utilizing different wavelengths of the light L1 to further enhance the photocatalysis efficiency.

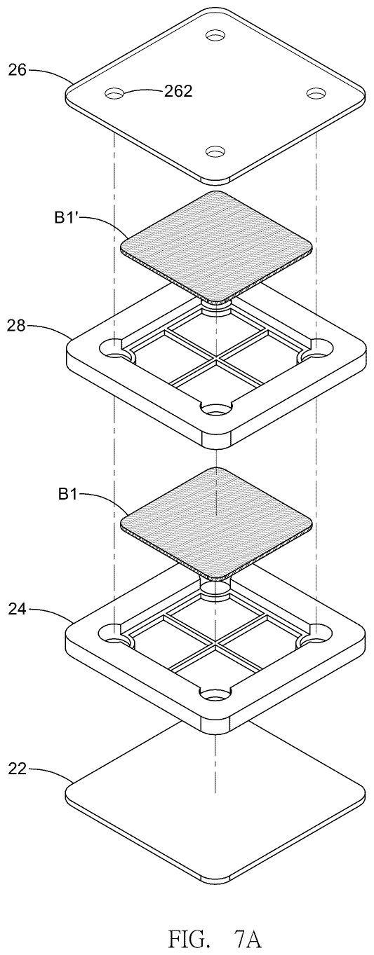

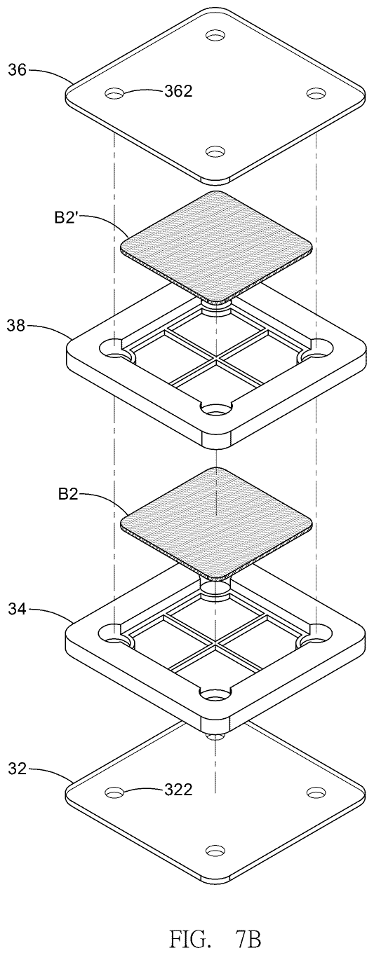

Please refer to FIG. 7A to FIG. 7B, which are schematic diagrams of the plurality of slot structures according to one embodiment of the present application. As shown in the figures, this embodiment is based on the first or second embodiment mentioned above. In this embodiment, a first auxiliary slot 28 is disposed on the first slot 24 of the first integrated component 20, positioned between the first slot 24 and the first top plate 26. An auxiliary photocatalytic component B1′ is disposed inside the first auxiliary slot 28 to further enhance the gas generation of the first integrated component 20.

Continued to above, in this embodiment, a second auxiliary slot 38 is disposed on the second slot 34 of the second integrated component 30, positioned between the second slot 34 and the second top plate 36. An auxiliary photocatalytic component B2′ is disposed inside the second auxiliary slot 38 to further enhance the gas generation of the second integrated component 30.

Continued to above, in one embodiment, a plurality of first auxiliary slots 28 can be stacked to form a photocatalytic device comprising a plurality of slots, not limited to this configuration.

In summary, the present application provides a three-dimensional stacked photocatalytic device, which pivots integrated components on a support frame and adjusts the rotation angle of the integrated components according to changes in external light (such as angle), thereby increasing the efficiency of gas generation by photocatalytic components. Additionally, a plurality of integrated components are pivoted on the support frame to capture energy from light of different wavelengths, further enhancing the efficiency of gas generation by photocatalytic components, overcoming the issue of poor efficiency in gas generation by known photocatalysis technologies.

1. A three-dimensional stacked photocatalytic device that receives a liquid, comprising:
a support frame, including a first pivot hole on a side; and
a first integrated component, comprising:
a first base plate, pivotally connected to the first pivot hole at a side;
a first accommodation slot, disposed on the first base plate, an inner side of the accommodation slot including a first photocatalytic component; and
a first top plate, disposed on the first accommodation slot, including a first upper through-hole perforated at a corner thereof corresponding to the first photocatalytic component, the first upper through-hole connecting to the inner side of the first accommodation slot;
wherein, the liquid enters the first accommodation slot through the first upper through-hole, the first base plate rotates by the first pivot hole and drives the first integrated component to rotate, directing a light of light onto the first top plate to pass through the first top plate and irradiate the first photocatalytic component in the first accommodation slot, causing the first photocatalytic component to decompose the liquid and generate a gas, the gas flows out through the first upper through-hole from the inner side of the first accommodation slot.

2. The three-dimensional stacked photocatalytic device of claim 1, wherein the first base plate includes a reflective layer.

3. The three-dimensional stacked photocatalytic device of claim 1, wherein the first photocatalytic component includes a first polymer material, disposed on the inner side of the first accommodation slot.

4. The three-dimensional stacked photocatalytic device of claim 3, wherein the first photocatalytic component further includes a first substrate, disposed at the inner side of the first accommodation slot, the first polymer material coated on the first substrate.

5. The three-dimensional stacked photocatalytic device of claim 1, wherein the support frame further includes a second pivot hole disposed on the same side and corresponding to an upper side of the first pivot hole.

6. The three-dimensional stacked photocatalytic device of claim 5, further comprising a second integrated component, comprising:
a connecting tube, connected to the first upper through-hole by an end;
a second base plate, pivotally connected to the second pivot hole at a side, the second base plate including a lower through-hole connects to the other end of the connecting tube.
a second accommodation slot, disposed on the second base plates, including a second photocatalytic component disposed at an inner side of the second accommodation slot, the second accommodation slot connected to the lower through-hole; and
a second top plate, disposed on the second accommodation slot, including a second upper through-hole perforated at a corner corresponding to the second photocatalytic component, which connects to the inner side of the second accommodation slot;
wherein, the second base plate rotates at the second pivot hole and drives the second integrated component to rotate, directing the light onto the second top plate to pass through the second top plate and irradiate the second photocatalytic component in the second accommodation slot, generating the gas, the gas flows out through the second upper through-hole from the inner side of the second accommodation slot.

7. The three-dimensional stacked photocatalytic device of claim 6, wherein the second photocatalytic component includes a second polymer material, which is disposed on the inner side of the second accommodation slot.

8. The three-dimensional stacked photocatalytic device of claim 7, wherein the second photocatalytic component further includes a second substrate, which is disposed on the inner side of the second accommodation slot, the second polymer material coated on the second substrate.

9. The three-dimensional stacked photocatalytic device of claim 1, wherein an first auxiliary accommodation slot is disposed on the first accommodation slot, set between the first accommodation slot and the first top plate, the first auxiliary accommodation slot including a first auxiliary photocatalytic component disposed on an inner side of the first auxiliary accommodation slot.

10. The three-dimensional stacked photocatalytic device of claim 6, wherein an second auxiliary accommodation slot is disposed on the second accommodation slot, set between the second accommodation slot and the second top plate, the second auxiliary accommodation slot including a second auxiliary photocatalytic component disposed on an inner side of the auxiliary accommodation slot.

11. The three-dimensional stacked photocatalytic device of claim 6, wherein the materials of the first and second photocatalytic components are different.

12. The three-dimensional stacked photocatalytic device of claim 1, wherein the gas comprises hydrogen and the liquid comprises water.
